(19) United States
(12) Patent Application Publication
(10) Pub. No.: US 2017/0116935 A1
(43) Pub. Date: Apr. 27, 2017

(54) LIQUID CRYSTAL DISPLAY DEVICE AND DRIVING METHOD THEREOF

(71) Applicant: Century Technology (Shenzhen) Corporation Limited, Shenzhen (CN)

(72) Inventors: WEN-QIANG YU, Shenzhen (CN); MING-TSUNG WANG, New Taipei (TW); CHIH-CHUNG LIU, New Taipei (TW); YI-HSIU CHENG, New Taipei (TW)

(21) Appl. No.: 14/957,817

(22) Filed: Dec. 3, 2015

(30) Foreign Application Priority Data
Oct. 27, 2015 (CN) 201510701254.0

(51) Int. Cl. G09G 3/36; G02F 1/1368; G02F 1/1362; G02F 1/133

(52) U.S. Cl. CPC G09G 3/3614; G02F 1/13306; G02F 1/1368; G02F 1/136286; G09G 3/3648; G09G 3/3677; G09G 3/3688; G09G 2300/0452; G09G 2300/0809

(57) ABSTRACT

A Liquid Crystal Display (LCD) device is provided. The LCD device includes: a plurality of first driving lines extending along a first direction; a plurality of second driving lines extending along a second direction perpendicular to the first direction, wherein the plurality of second driving lines insulatively intersect with the plurality of first driving lines to define a plurality of pixel regions; a plurality of pixel electrodes respectively arranged at the plurality of pixel regions; a first driving circuit coupled with the plurality of first driving lines; and a second driving circuit coupled with the plurality of second driving lines; wherein the first driving circuit and the second driving circuit drive the first and second driving lines to output different voltage to cause two adjacent same color pixel electrodes arranged along the second direction to have different polarity.

### FIELD

The subject matter herein generally relates to a liquid crystal display device and a driving method thereof.

### BACKGROUND

Liquid Crystal Display (LCD) devices are widely used in various electronic devices, for example, personal computers, mobile phones, tablets. Generally, a LCD device can include a first driving circuit, a second driving circuit, a plurality of scanning lines, a plurality of data lines and a plurality of pixel units. Adjacent scanning lines and data lines define a pixel unit. Each pixel unit can include four sub pixels, for example, RGBW. The first driving circuit can be configured to one of the plurality of data lines and the second driving circuit can be configured to periodically change polarity of sub pixels coupled to the one of the plurality of data lines.

### BRIEF DESCRIPTION OF THE DRAWINGS

Implementations of the present technology will now be described, by way of example only, with reference to the attached figures.

FIG. 1 is a diagrammatic view of a first exemplary embodiment of a LCD device.

FIG. 2 is a diagrammatic view of an exemplary embodiment of a configuration of sub pixels of the LCD device in FIG. 1.

FIG. 3 is a diagrammatic view of an exemplary embodiment of a configuration of polarity of pixel electrodes of the LCD device in FIG. 2.

FIG. 4 is a diagrammatic view of a second exemplary embodiment of a configuration of polarity of pixel electrodes of the LCD device in FIG. 1.

FIG. 5 is a diagrammatic view of a third exemplary embodiment of a LCD device.

FIG. 6 is a diagrammatic view of an exemplary embodiment of a configuration of pixel electrodes of the LCD device in FIG. 5.

FIG. 7 is a diagrammatic view of an exemplary embodiment of a configuration of polarity of pixel electrodes of the LCD device in FIG. 5.

FIG. 8 is a diagrammatic view of a fourth exemplary embodiment of a configuration of polarity of pixel electrodes of the LCD device in FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

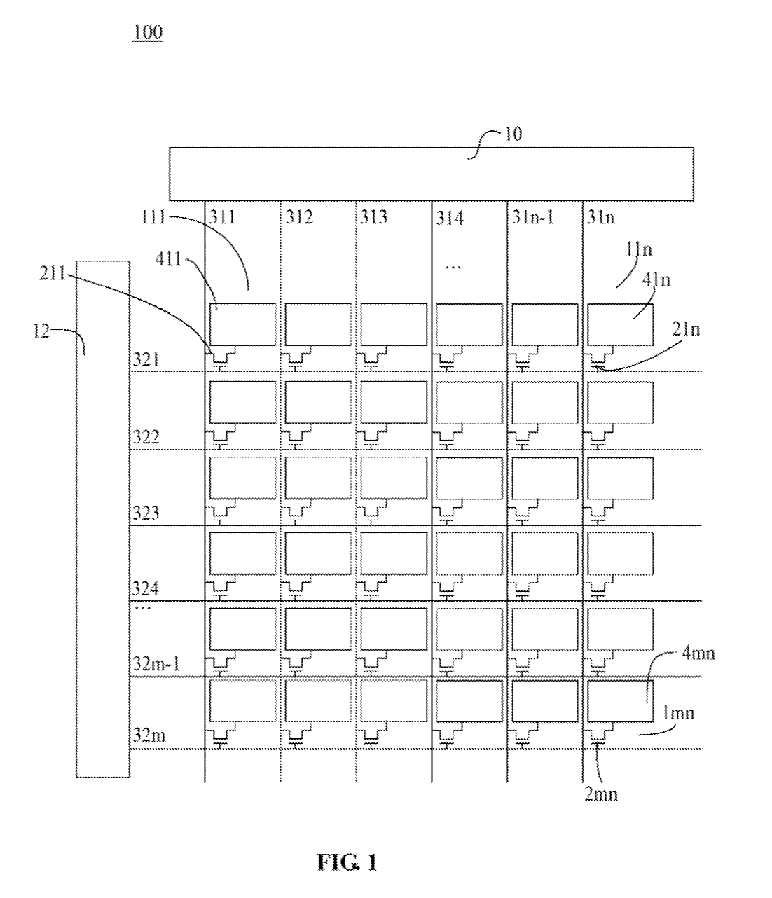

FIG. 1 illustrates a first exemplary embodiment of a LCD device. In the illustrated embodiment, the LCD device 100 can include a first driving circuit 10, a second driving circuit 12, a plurality of first driving lines 311-31n (n is a positive integer and n is greater than 1) extending along a first direction, a plurality of second driving lines 321-32m (m is a positive integer and n is greater than 1) extending along a second direction. The first driving lines 311-31n intersect the second driving lines 321-32m to define a plurality of pixel regions 111-1mn. A plurality of Thin Film Transistors (TFTs) 211-2mn and a plurality of pixel electrodes 411-4mn are respectively arranged at the plurality of pixel regions 111-1mn.

The first driving circuit 10 can be electrically coupled to the plurality of first driving lines 311-31n to drive the plurality of first driving lines 311-31n to output different output voltages so as to drive the LCD device 100 to display images. The second driving circuit 12 can be electrically coupled to the plurality of second driving lines 321-32m to drive the plurality of first driving lines 321-32n to output different output voltages so as to drive the LCD device 100. In the illustrated embodiment, the first direction can be perpendicular to the second direction so as to cause the first driving lines 311-31n to be orthogonal to the second driving lines 321-32m. In the illustrated embodiment, the first direction is vertical while the second direction is horizontal. The first driving circuit 10 can be a source driving circuit while the second driving circuit 12 can be a gate driving circuit. In at least one embodiment, the first driving circuit 10 can be a gate driving circuit while the second driving circuit 12 can be a source driving circuit.

The plurality of TFTs 211-2mn is arranged at an intersection of the first driving lines 311-31n and the second driving lines 321-32m. Gates of the TFTs 211-2mn can be electrically coupled to the first driving lines 311-31n, grids of the TFTs 211-2mn can be electrically coupled to the second driving lines 32a-32m, and drains of the TFTs 211-2mn can be electrically coupled to the pixel electrodes 411-4mn. In the illustrated embodiment, the source of each of the TFTs 211-2mn can be coupled to a first driving line which is positioned at a left side of the TFT. For example, the source of the first TFT 211 is coupled to the first driving line which is positioned at the left side of the first TFT 211, the source of the n^{th} TFT 21n is coupled to the first driving line which is positioned at the left side of the n^{th} TFT 21n, and the source of the mn^{th} TFT 2mn is coupled to the first driving line which is positioned at the left side of the mn^{th} TFT 2mn.

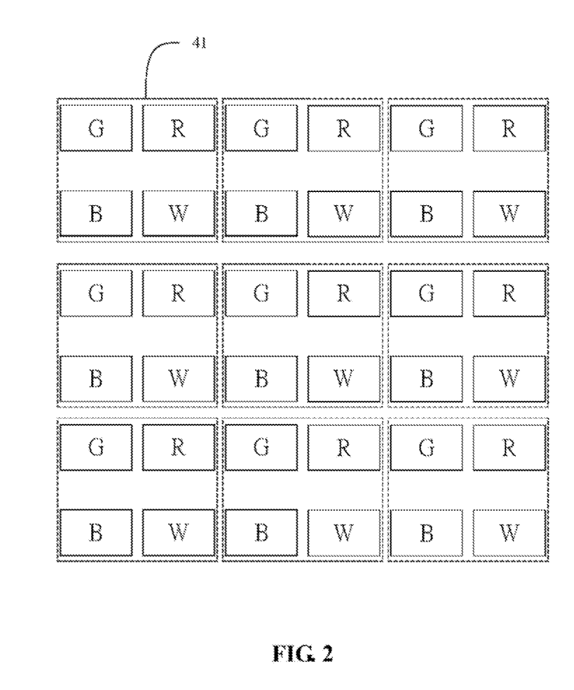

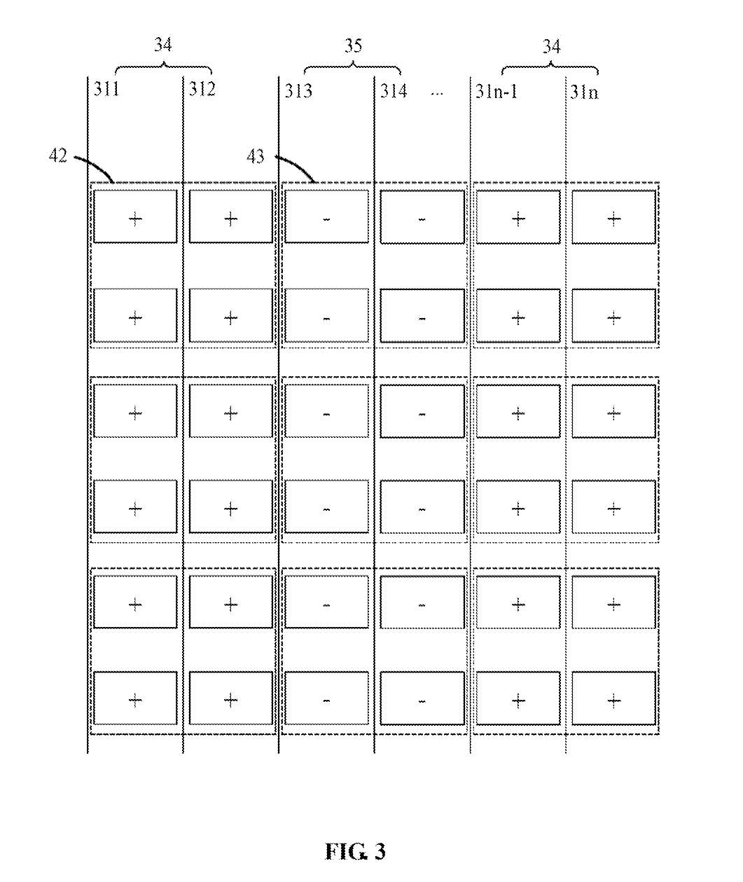

As illustrated in FIGS. 2 and 3, the pixel electrodes 411-4mn can include Red (R) pixel electrodes, Green (G) pixel electrodes, Blue (B) pixel electrodes and White (W) pixel electrodes. The GRBW pixel electrodes can be arranged in a substantially rectangle shape. Adjacent G, R, B, W electrodes arranged in a substantially rectangle shape can form a pixel unit 41.

As illustrated in FIG. 3, the plurality of pixel units 41 can be classified into a plurality of first pixel units 42 and a plurality of second pixel units 43. The first pixel groups 42 and the second pixel groups 43 can be arranged alternatively along the second direction. Each of the pixel units 42 or 43 can consist of two adjacent columns of pixel electrodes having same polarity. The first pixel units 42 and the second pixel units 43 have different polarity. The polarity of the first pixel units 42 and the polarity of the second pixel units 43 can be changed synchronously so that the polarity of the first pixel units 42 and the polarity of the second pixel units 43 remain different at all time.

The first driving lines 311-31n can be divided into a plurality of first driving groups 34 and a plurality of second driving groups 35. The plurality of first driving groups 34 and the plurality of second driving groups 35 can be alternatively arranged and can be driven by the first driving circuit 10 to remain different polarity, for example, the polarity of the first driving groups 34 is positive (+) while the polarity of the second driving groups 35 is negative (−); the polarity of the first driving groups 34 is negative (−) while the polarity of the second driving groups 35 is positive (+).

For example, in the illustrated embodiment, the first driving circuit 10 and the second driving circuit 12 can drive the first pixel units 42 to be positive (+), and drive the second pixel units 43 to be negative (−). When the first driving circuit 10 and the second driving circuit 12 change output voltages thereof, the polarity of the first and second driving groups 34 and 35 changes accordingly so as to cause the polarity of the first pixel units 42 to be negative (−) and the second pixel units to be positive (+). Thus, the polarity of the first and second pixel units 42, 43 remain different at any time. When the LCD device 100 displays an image in a single color, for example, blue, red, white or green, the polarity of pixel electrodes with same color in two adjacent pixel units along the second direction is different.

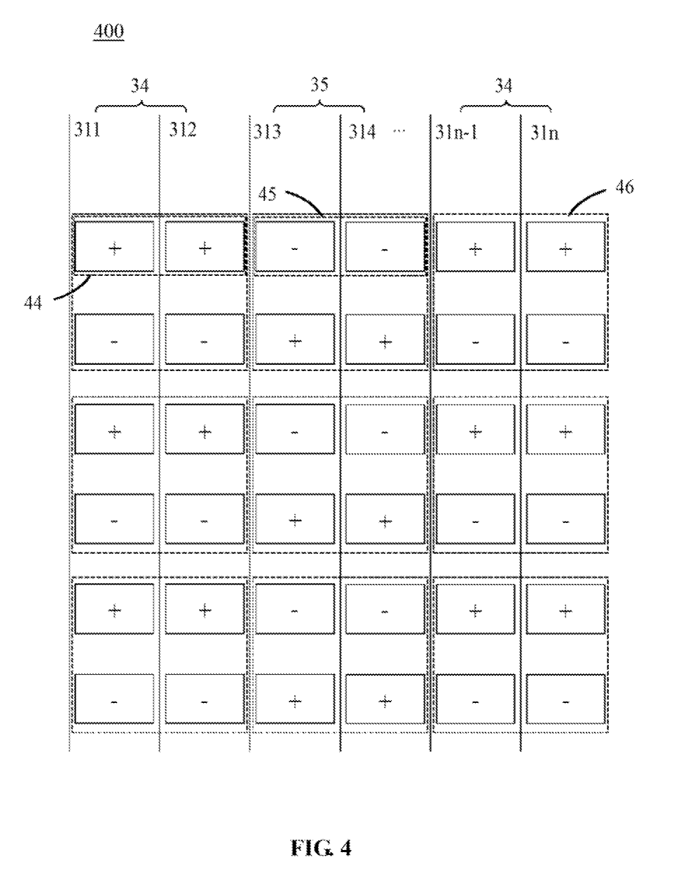

FIG. 4 illustrates a second exemplary embodiment of a LCD device 400. The LCD device 400 in a similar structure with the LCD device 100 and any element of the LCD device 400 not specifically described herein can be assumed to be the same as in the LCD device 100. The plurality of pixel electrodes 411-4mn can be divided into a plurality of first pixel groups 44 and a plurality of second pixel groups 45. The first pixel groups 44 and the second pixel groups 45 can be arranged alternatively along both the first direction and the second direction. Each first pixel group 44 together with an adjacent second pixel group 45 arranged along the first direction can form a pixel unit 46. Each of the pixel groups 44 or 45 can consist of two adjacent pixel electrodes having same polarity arranged along the second direction. The first pixel groups 44 and the second pixel groups 45 have different polarity. The polarity of the first pixel groups 44 and the polarity of the second pixel groups 45 can be changed synchronously so that the polarity of the first pixel groups 44 and the polarity of the second pixel groups 45 remain different at all time.

For example, in the illustrated embodiment, the first driving circuit 10 and the second driving circuit 12 can drive the first pixel groups 44 to be positive (+), and drive the second pixel groups 45 to be negative (−). When the first driving circuit 10 and the second driving circuit 12 change output voltages thereof, the polarity of the first and second driving groups 34 and 35 changes accordingly so as to cause the polarity of the first pixel groups 44 to be negative (−) and the second pixel groups 45 to be positive (+). Thus, the polarity of the first and second pixel groups 44, 45 remain different at all time. When the LCD device 400 displays an image in a single color, for example, blue, red, white or green, the polarity of pixel electrodes with same color in two adjacent pixel units along the second direction is different.

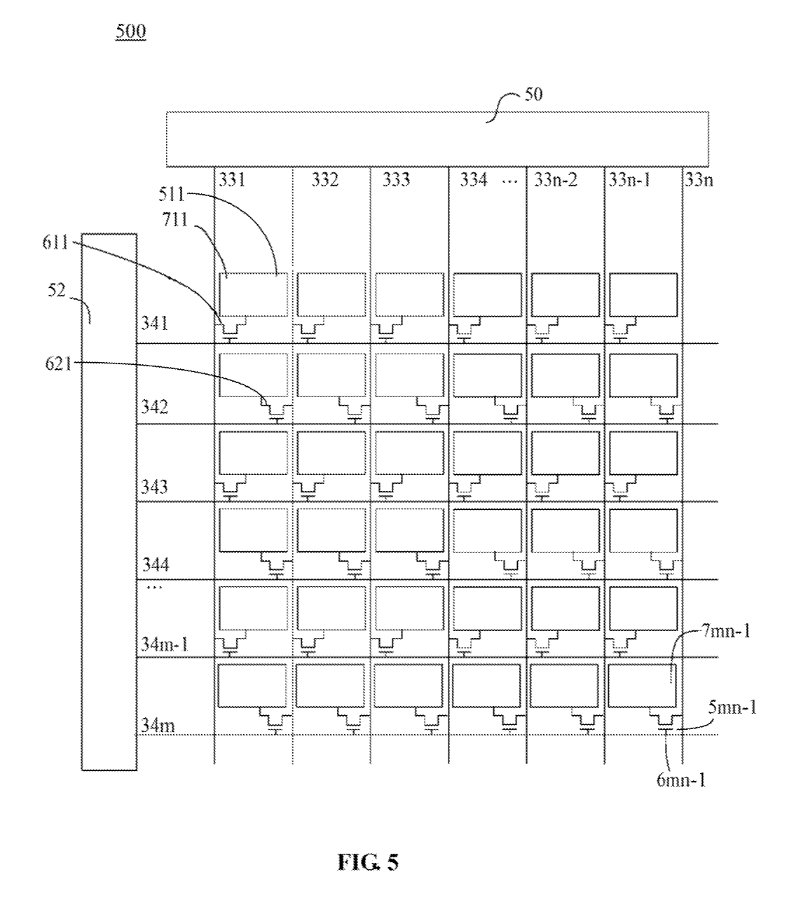

As illustrated in FIG. 5, the LCD device 500 can include a first driving circuit 50, a second driving circuit 52, a plurality of first driving lines 331-33n (n is a positive integer and n is greater than 1) extending along a first direction, a plurality of second driving lines 341-34m (m is a positive integer and n is greater than 1) extending along a second direction. The first driving lines 331-33n intersect the second driving lines 341-34m to define a plurality of pixel regions 511-5mn. A plurality of TFTs 611-6mn and a plurality of pixel electrodes 711-7mn are respectively arranged at the plurality of pixel regions 511-5mn.

The first driving circuit 50 can be electrically coupled to the plurality of first driving lines 331-33n to drive the LCD device 500. The second driving circuit 52 can be electrically coupled to the plurality of second driving lines 341-34m to drive the LCD device 500. In the illustrated embodiment, the first direction can be perpendicular to the second direction so as to cause the first driving lines 331-33n to be orthogonal to the second driving lines 341-34m. In the illustrated embodiment, the first direction is vertical while the second direction is horizontal. The first driving circuit 50 can be a source driving circuit while the second driving circuit 52 can be a gate driving circuit. In at least one embodiment, the first driving circuit 50 can be a gate driving circuit while the second driving circuit 52 can be a source driving circuit.

The plurality of TFTs 611-6mn is arranged at an intersection of the first driving lines 331-33n and the second driving lines 341-34m. Gates of the TFTs 611-6mn can be electrically coupled to the first driving lines 331-33n, grids of the TFTs 611-6mn can be electrically coupled to the second driving lines 34a-34m, and drains of the TFTs 611-6mn can be electrically coupled to the pixel electrodes 711-7mn. In the illustrated embodiment, the source of two adjacent TFTs arranged along the first direction can be coupled to first driving lines which are respectively positioned at different sides of the TFTs. For example, the source of the first TFT 611 is coupled to the first driving line which is positioned at the left side of the first TFT 611, the source of the second TFT 621 is coupled to the first driving line which is positioned at the right side of the second TFT 621.

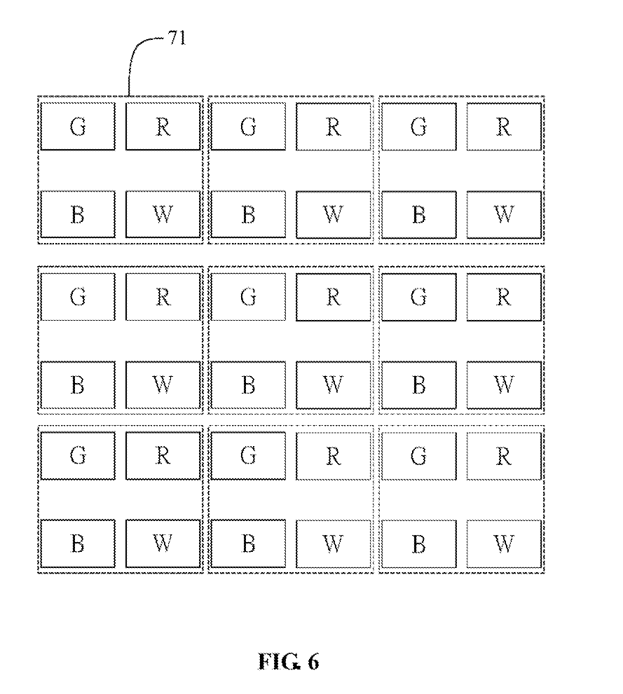

As illustrated in FIG. 6, the pixel electrodes 711-7mn can include Red (R) pixel electrodes, Green (G) pixel electrodes, Blue (B) pixel electrodes and White (W) pixel electrodes. The RGBW pixel electrodes can be arranged in a substantially rectangle shape. Adjacent R, G, B, W electrodes arranged in a substantially rectangle shape can form a pixel unit 71.

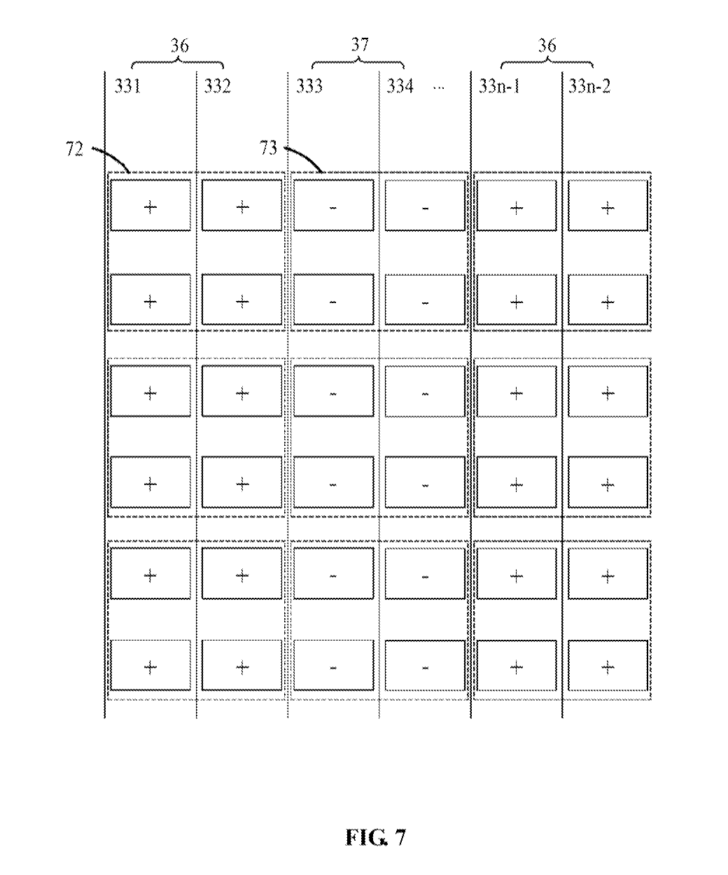

As illustrated in FIG. 7, the plurality of pixel units 71 can be divided into a plurality of first pixel units 72 and a plurality of second pixel units 73. The first pixel units 72 and the second pixel units 73 can be arranged alternatively along the second direction. Each of the pixel units 72 or 73 can consist of two adjacent columns of pixel electrodes having same polarity. The first pixel units 72 and the second pixel units 73 have different polarity. The polarity of the first pixel units 72 and the polarity of the second pixel units 73 can be changed synchronously so that the polarity of the first pixel units 72 and the polarity of the second pixel units 73 remain different at all time.

The first driving lines 331-33n can be divided into a plurality of first driving groups 36 and a plurality of second driving groups 37. The plurality of first driving groups 36 and the plurality of second driving groups 37 can be alternatively arranged and can be driven by the first driving circuit 50 to remain different polarity, for example, the polarity of the first driving groups 36 is positive (+) while the polarity of the second driving groups 37 is negative (−); the polarity of the first driving groups 36 is negative (−) while the polarity of the second driving groups 37 is positive (+).

For example, in the illustrated embodiment, the first driving circuit 50 and the second driving circuit 52 can drive the first pixel units 72 to be positive (+), and drive the second pixel units 73 to be negative (−). When the first driving circuit 50 and the second driving circuit 52 change output voltages thereof, the polarity of the first and second driving groups 36 and 37 changes accordingly so as to cause the polarity of the first pixel units 72 to be negative (−) and the second pixel units 73 to be positive (+). Thus, the polarity of the first and second pixel units 72, 73 remain different at all time. When the LCD device 500 displays an image in a single color, for example, blue, red, white or green, the polarity of pixel electrodes with same color in two adjacent pixel units along the second direction is different.

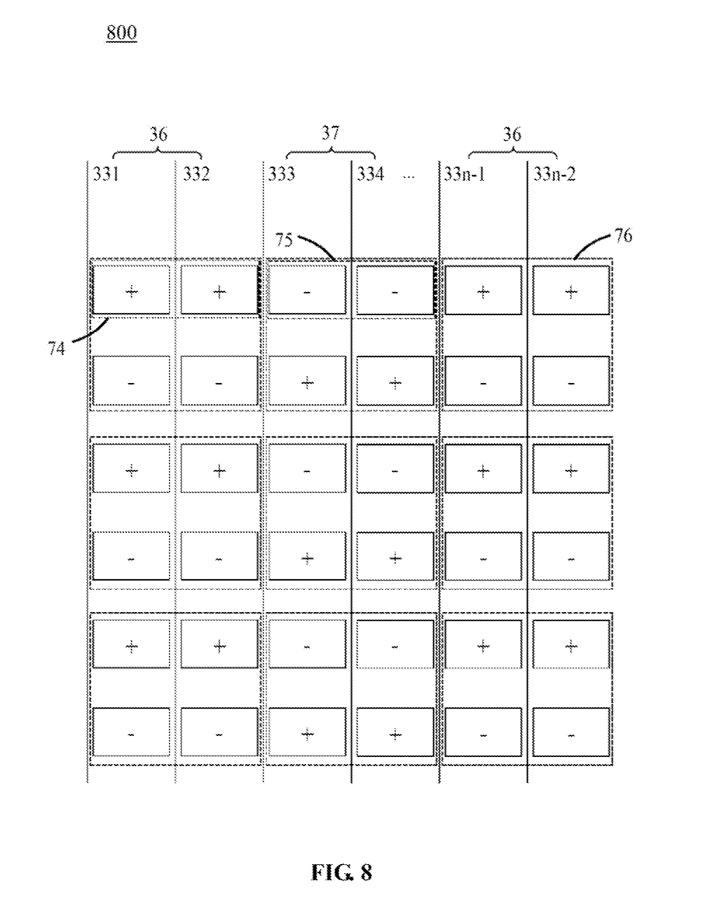

FIG. 8 illustrates a fourth exemplary embodiment of a LCD device 800. The LCD device 800 is in a similar structure with the LCD device 500 and any element of the LCD device 800 not specifically described herein can be assumed to be the same as in the LCD device 500. The plurality of pixel electrodes 711-7mn can be divided into a plurality of first pixel groups 74 and a plurality of second pixel groups 75. The first pixel groups 74 and the second pixel groups 75 can be arranged alternatively along both the first direction and the second direction. Each first pixel group 74 together with an adjacent second pixel group 75 arranged along the first direction can form a pixel unit 76. Each of the pixel groups 74 or 75 can consist of two adjacent pixel electrodes having same polarity arranged along the second direction. The first pixel groups 74 and the second pixel groups 75 have different polarity. The polarity of the first pixel groups 74 and the polarity of the second pixel groups 75 can be changed synchronously so that the polarity of the first pixel groups 74 and the polarity of the second pixel groups 75 remain different at all time.

For example, in the illustrated embodiment, the first driving circuit 50 and the second driving circuit 52 can drive the first pixel groups 74 to be positive (+), and drive the second pixel groups 75 to be negative (−). When the first driving circuit 50 and the second driving circuit 52 change output voltages thereof, the polarity of the first and second driving groups 74 and 75 changes accordingly so as to cause the polarity of the first pixel groups 74 to be negative (−) and the second pixel groups 75 to be positive (+). Thus, the polarity of the first and second pixel groups 74, 75 remain different at all time. When the LCD device 800 displays an image in a single color, for example, blue, red, white or green, the polarity of pixel electrodes with same color in two adjacent pixel units along the second direction is different

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A Liquid Crystal Display (LCD) device comprising:
a plurality of first driving lines extending along a first direction;
a plurality of second driving lines extending along a second direction perpendicular to the first direction, wherein the plurality of second driving lines insulatively intersect with the plurality of first driving lines to define a plurality of pixel regions;
a plurality of pixel electrodes respectively arranged at the plurality of pixel regions; and include Green (G) pixel electrodes, Red (R) pixel electrodes, Blue (B) pixel electrodes and White (W) pixel electrodes, wherein adjacent G, R, B, W pixel electrodes arranged in a substantially rectangle shape to form a pixel unit;
a plurality of Thin Film Transistors (TFTs) respectively arranged at the plurality of pixel regions and coupled the plurality of the pixel electrodes with the plurality of first and second driving lines;
a first driving circuit coupled with the plurality of first driving lines; and
a second driving circuit coupled with the plurality of second driving lines, wherein the first driving circuit and the second driving circuit drive the first and second driving lines to output different voltage to the plurality of TFT to cause any two adjacent same color pixel electrodes arranged along the second direction to have different polarity.

2. The LCD device according to claim 1, wherein the first driving circuit is a source driving circuit and the second driving circuit is a gate driving circuit.

3. The LCD device according to claim 2, wherein each of the TFT is coupled to a first driving line positioned at a left side of the TFT.

4. The LCD device according to claim 3, wherein the plurality of pixel electrodes is divided into a plurality of first pixel groups having first polarity and a plurality of second pixel groups having second polarity different from the first polarity, the plurality of first pixel groups and the plurality of second pixel groups alternatively arranged along the second direction.

5. The LCD device according to claim 4, wherein the first driving circuit and the second driving circuit drive the first and second driving lines to output different voltage to synchronously change polarity of the first pixel groups and polarity of the second pixel groups so as to cause the polarity of the first pixel groups and the polarity of the second pixel groups remains different at all time.

6. The LCD device according to claim 4, wherein each of the first and the second pixel groups consists of two adjacent column pixel electrodes arranged along the second direction.

7. The LCD device according to claim 4, wherein each of the first and the second pixel groups consists of two adjacent pixel electrodes arranged along the second direction.

8. The LCD device according to claim 7, wherein the plurality of first pixel groups and the plurality of second pixel groups are alternatively arranged along the first direction.

9. The LCD device according to claim 2, wherein two adjacent TFTs arranged along the first direction are respectively coupled to two first driving lines positioned at different sides of the TFTs.

10. The LCD device according to claim 9, wherein the plurality of pixel electrodes is divided into a plurality of first pixel groups having first polarity and a plurality of second pixel groups having second polarity different from the first polarity, the plurality of first pixel groups and the plurality of second pixel groups alternatively arranged along the second direction.

11. The LCD device according to claim 10, wherein the first driving circuit and the second driving circuit drive the first and second driving lines to output different voltage to synchronously change polarity of the first pixel groups and polarity of the second pixel groups so as to cause the polarity of the first pixel groups and the polarity of the second pixel groups remains different at all time.

12. The LCD device according to claim 10, wherein each of the first and the second pixel groups consists of two adjacent column pixel electrodes arranged along the second direction.

13. The LCD device according to claim 10, wherein each of the first and the second pixel groups consists of two adjacent pixel electrodes arranged along the second direction.

14. The LCD device according to claim 13, wherein the plurality of first pixel groups and the plurality of second pixel groups are alternatively arranged along the first direction.

15. A drive method comprising:
driving, at a LCD device, two adjacent same color pixel electrodes along a first direction to have different polarity, wherein source lines of the LCD device extending along the first direction.

16. The method according to claim 15, further comprising:
dividing, at the LCD device, pixel electrodes arranged in a substantially rectangle into a plurality of first pixel groups and a plurality of second pixel groups, the first pixel groups and the second pixel groups alternatively arranged along the first direction;
driving, at the LCD device, the pixel electrodes in the first pixel groups having first polarity, and the pixel electrodes in the second pixel groups having second polarity different from the first polarity.

17. The method according to claim 15, wherein each of the first and the second pixel groups consists of two adjacent column pixel electrodes arranged along the second direction.

18. The method according to claim 15, wherein each of the first and the second pixel groups consists of two adjacent pixel electrodes arranged along the second direction.

19. The method according to claim 18, wherein the plurality of first pixel groups and the plurality of second pixel groups are alternatively arranged along the first direction.
